(19) United States
(12) Patent Application Publication
(10) Pub. No.: US 2014/0239236 A1
(43) Pub. Date: Aug. 28, 2014

(54) METHOD FOR REDUCING GRAPHITE OXIDE

(71) Applicants: Deepak Shukla, Webster, NY (US); Debasis Majumdar, Manchester, NH (US)

(72) Inventors: Deepak Shukla, Webster, NY (US); Debasis Majumdar, Manchester, NH (US)

(21) Appl. No.: 14/269,235

(22) Filed: May 5, 2014

Related U.S. Application Data
(63) Continuation-in-part of application No. 13/352,614, filed on Jan. 18, 2012.

(51) Int. Cl. C01B 31/04; H01B 1/04; B01J 19/12; H01B 1/24

(52) U.S. Cl. CPC C01B 31/043; H01B 1/24; H01B 1/04; B01J 19/123
USPC 252/511; 204/157.47

(57) ABSTRACT

Graphite oxide can be converted to its reduced form (r-GO) using exposing UV radiation having a peak wavelength (λₘₐₓ) of less than 400 nm while being maintained at a temperature that is greater than room temperature. This conversion method is efficient and can be carried out with various forms of graphite oxide samples, below atmospheric pressure, or in a reducing environment.

### CROSS-REFERENCE TO RELATED APPLICATIONS

The present application is a Continuation-in-part application of U.S. application Ser. No. 13/352,614, filed Jan. 18, 2012, by Thomas N. Blanton, et al., and entitled, “METHOD FOR REDUCING GRAPHITE OXIDE.”

### FIELD OF THE INVENTION

This invention relates to a method for converting graphite oxide to reduced graphite oxide (r-GO) using exposing UV radiation while the graphite oxide is being heated.

### BACKGROUND OF THE INVENTION

Graphite materials and graphene materials are useful for a number of applications due to their important properties such as mechanical strength and electrical conductivity. For example, graphene has potential use in electronics and materials sciences. Small sheets of graphite and graphene materials are of particular interest, which can be as thin as a single atom. These materials have a variety of excellent properties that make them desirable for use in semiconducting applications among other applications.

However, sheets of graphite and graphene are hard to produce, in part due to the fact that the sheets are typically hydrophobic and often agglomerate in processing media such as organic solvents. Moreover, starting materials of graphite oxide and graphene oxide are also difficult to handle and reduce to graphite and graphene, respectively.

Graphite oxide, sometimes known as graphene oxide, is a useful precursor to the bulk production of graphene-containing materials because graphite oxide can be prepared from large quantities of relatively inexpensive graphite powders. Graphite oxide is also particularly useful for making composites with polymers, metals, and metal-containing compounds for various industrial applications. The reduction of graphite oxide or graphene oxide is one way to produce graphite or graphene, but this is not easy. U.S. 2010/0237296 (Gilje) describes the use of hydrazine for reduction processes. Thermal reduction is also known.

U.S. Patent Application Publication 2011/0079748 (Ruoff et al.) describes a method for reducing exfoliated graphite oxide in propylene carbonate by bath sonication during heating at 150° C.

As summarized by Cote, Crus-Silva, and Huang, J. Am. Chem. Soc. 131, 2009, pp. 11027-11032, various methods have been described for making graphite oxide from graphite using various chemical oxidants followed by gentle exfoliation. Such reactions typically provide graphene sheets with carboxylic acid, phenol hydroxyl, or epoxide groups to provide a generally water-dispersible and insulating material that can be reduced to form chemically modified graphene or reduced graphite oxide (r-GO) in which a large portion of oxygen-containing functional groups are removed by reactions with chemical reducing agents such as hydrazine or its derivatives. Alternatively, graphite oxide can be reduced using thermal treatment (typically at least 900° C.) in various inert or reducing environments. In either case, such chemical thermal reducing treatments could be difficult or cause problems if the graphite oxide is blended in a composite with materials that can be chemically or thermally degraded, or in which the graphite oxide is not readily accessible.

The noted authors Cote et al. describe a method for “flash reduction” of graphite oxide in which samples of graphite oxide are exposed to a pulsed Xenon flash typically having a distribution of radiation. While these processes may have advantages over chemical and thermal reduction methods, the conversion of graphite oxide to r-GO using flash reduction at the relatively higher wavelengths fails to convert at least 40 weight % of the exposed graphite oxide. This is considerably inefficient for most industrial purposes and particularly so if the exposing radiation cannot readily reach the graphite oxide, for example, if the graphite oxide is “buried” or in a composite material.

Thus, there is a need for an improved and more efficient method for converting graphite oxide (GO) to reduced graphite oxide (r-GO).

### SUMMARY OF THE INVENTION

This invention provides a method for reducing graphite oxide comprising:

exposing a sample comprising graphite oxide (GO) to UV radiation having a peak wavelength of less than 400 nm to change at least 40% of the graphite oxide (GO) to reduced graphite oxide (r-GO), wherein this exposing is carried out when the sample is at a temperature of at least 50° C. and up to and including 450° C.

The method of this invention is simple compared to many processes described in the art for reducing graphite oxide. The conversion rate is greater than 40% and the graphite oxide is simply exposed to UV radiation having a peak wavelength (λₘₐₓ) of less than 400 nm, for example a peak wavelength of at least 150 nm. The reduced graphite oxide (r-GO) has improved conductivity compared to the graphite oxide.

The method of this invention can be advantageously used to convert GO to r-GO by patternwise exposure to appropriate radiation. Such patternwise exposure can be implemented through the use of suitable mask and lasers or other exposure means known in the art. Thus, the method of this invention can be used to prepare devices such as electronic devices or components that are used in such devices.

### DETAILED DESCRIPTION OF THE INVENTION

The following discussion is directed to various embodiments of the present invention and while some embodiments can be preferred for specific uses, the disclosed embodiments should not be interpreted or otherwise considered to be limited to the scope of the present invention, as claimed below. In addition, one skilled in the art will understand that the following disclosure has broader application than is explicitly described and the discussion of any embodiment is not intended to limit the scope of the present invention to any described embodiment.

### Definitions

“Graphene” generally refers to a material having less than 10 graphitic layers that are characterized by an “infinite” two-dimensional basal plane having a hexagonal lattice structure and various edge functionalities, which can include, for example carboxylic acid groups, hydroxyl groups, epoxide groups, and ketone groups. “Graphene nano-ribbons” are a special class of graphene, which are similarly characterized by a two-dimensional basal plane, but with a large aspect ratio of their length to their width. Graphene can be provided in any suitable form including intercalated graphene, non-intercalated graphene, chemically-functionalized graphene, stabilized graphene, and plain graphene. It can be in the form of sheets, ribbons, multilayer sheets, a single atomically thick layer, and any other form used in the art.

As used herein, the terms “graphite oxide” (GO) and “reduced graphite oxide” (r-GO) are used to also define and include graphene oxide and graphene, respectively.

Unless otherwise specified, the singular forms “a”, “an”, and “the” include plural referents also. Terms that are not explicitly defined in the present application are to be understood to have meaning that is commonly accepted by those skilled in the art. If the construction of a term would render it meaningless or essentially meaningless in this context, the term's definition should be taken from a standard dictionary.

Thus, the method of the present invention for reducing graphite oxide comprises exposing a sample comprising graphite oxide (GO) to ultraviolet (UV) radiation having a peak wavelength of less than 400 nm to change at least 40% (typically at least 50% or even at least 60%) of the original graphite oxide (GO) in the sample to reduced graphite oxide (r-GO). XRD data can be collected using a Rigaku D2000 Bragg Brentano diffractometer equipped with a copper rotating anode, diffracted beam monochromator tuned to CuKα radiation, and a scintillation detector.

The time for exposure can vary depending upon the exposure radiation and equipment, exposure temperature, and exposure environment. A skilled worker would be able, with routine experimentation, to determine the optimum exposure time for a given set of conditions and GO sample.

More generally, the method of this invention can comprise exposing the sample comprising graphite oxide (GO) to UV radiation sufficient to provide at least 0.01 J/cm², or typically at least 0.1 J/cm² and up to and including 10⁶ J/cm², to provide at least 40% reduced graphite oxide (r-GO) in the sample. This UV radiation can then be provided using any suitable source having a peak wavelength (λₘₐₓ) of less than 400 nm, for example a peak wavelength of less than 370 nm, or even less than 230 nm, or even more typically, a peak wavelength of at least 150 nm.

The sample comprising graphite oxide (GO) can be irradiated (exposed) using suitable UV radiation uniformly so that the entire sample, or at least an entire surface of graphite oxide (GO) is exposed to provide reduced graphite oxide (r-GO). In other embodiments, the method comprises exposing the sample comprising graphite oxide (GO) to UV radiation to provide reduced graphite oxide (r-GO) in a random pattern in the sample. In other embodiments, the method comprises exposing the sample comprising graphite oxide (GO) to UV radiation to provide reduced graphite oxide (r-GO) in a predetermined non-random pattern in the sample.

The sample comprising graphite oxide (GO) is exposed to UV radiation to provide reduced graphite oxide (r-GO) while the sample comprising graphite oxide (GO) is being heated to, or is maintained, at a temperature above room temperature (20-25° C.) and up to and including 450° C., or at least 50° C., or even at least 75° C. and up to and including 400° C.

In addition to the heating environment described above, the method of this invention can also comprise exposing the sample comprising graphite oxide (GO) to UV radiation to provide reduced graphite oxide (r-GO) while the sample comprising graphite oxide (GO) at a pressure of less than 760 torr or typically at a pressure of less than 100 torr, or more likely at less than 10 torr or even less than 1 torr.

In other embodiments, the UV exposure in the method of this invention can be carried out to advantage while the sample is in a reducing environment. A typical reducing environment can comprise reduced oxygen partial pressure, for example, in the presence of one or more inert gases such as nitrogen, argon, and helium.

A skilled worker would be able to determine optimal conditions for reduction of at least 40% of GO to r-GO according to the present invention by routine experimentation using predetermined UV exposure wavelength, UV exposure equipment, and UV exposure time, as well as by maintaining the sample at a desired temperature, reducing environment, or both desired temperature reducing environment. There are various combinations of UV radiation exposure, heat, and reduced pressure conditions that can be used, so that the best combination of conditions can be readily determined by a skilled worker in the art. However, in some embodiments, the optimal reduction conditions can be ambient temperature and pressure.

The sample comprising graphite oxide (GO) that is treated using the present invention can be provided as a surface coating on a substrate to provide reduced graphite oxide (r-GO) in the surface coating. In other embodiments, the sample comprising graphite oxide (GO) can be provided as a surface coating on a non-oxidative substrate to provide r-GO in the surface coating. In still other embodiments, the sample comprising GO can be provided as part of or an entire article to provide reduced graphite oxide (r-GO) in the article.

In addition, the sample comprising graphite oxide (GO) that is exposed to UV radiation is a component of a composite comprising one or more metals, metal-containing compounds, polymers or other organic compounds, inorganic materials including ceramics, glass, and clays, to provide reduced graphite oxide (r-GO) in the composite. For example, the sample comprising graphite oxide (GO) can be a component of a composite comprising one or more electronically conductive polymers, to provide reduced graphite oxide (r-GO) in the composite. Such composites can comprise one or more electronically conductive polymers that are a thiophene-containing polymer, aniline-containing polymer, or a pyrrole-containing polymer.

In still other embodiments, the method can comprise exposing the sample comprising graphite oxide (GO) that is in the form of a relatively thin coating having a thickness of less than 10 μm, to provide reduced graphite oxide (r-GO) in the coating.

Moreover, in some embodiments, the method can comprise UV exposing a sample comprising graphite oxide (GO) that is at least partially underneath a non-graphite oxide material (contains less than 1 weight % graphite oxide), to provide reduced graphite oxide (r-GO) at least partially underneath the non-graphite oxide material.

While many samples comprising exposed graphite oxide are in multiple layers, some other samples comprising graphite oxide (GO) are in the form of a single layer.

The present invention can be carried out using generally available equipment and procedures that would be readily understood by one skilled in the art in view of the specific teaching provided herein. For example, UV exposure can be provided, for example, using mercury light sources, UV light sources, UV lasers, or synchrotron. Heating during UV radiation exposure can be accomplished for example, using resistive heating apparatus and sample temperature can be measured using a thermocouple or other known measurement means. Reduced pressures can be achieved using vacuum pumps or other known means.

The following Example is provided to illustrate the practice of this invention and is not meant to be limiting in any manner.

Graphite Oxide (GO), in dispersion form, was obtained from Angstron Materials; at a concentration of 0.5 weight percent GO in water. As supplied, this product contained a small amount (less than 5 weight % solids) of graphite (“gp”).

The presence of GO in a sample was confirmed using X-ray Diffraction (XRD), based on the observation of a diffraction peak in the range of 7 to 14 degrees two-theta. The presence of reduced Graphite Oxide (r-GO) in a sample was confirmed using XRD, based on the observation of a diffraction peak in the range of 21 to 26 degrees two-theta. The ratio of the normalized XRD peak area of the r-GO diffraction peak to the GO diffraction peak (IₙₒᵣₘGO/Iₙₒᵣₘr-GO) with a value greater than or equal to 0.667 is an indication that conversion of GO to r-GO is at least 40% of the original amount of GO.

Conductivity and resistivity were determined using an Atomic Force Microscope (AFM).

Polyethylenedioxythiophene/polystyrene sulfonic acid (PEDOT), in dispersion form, was obtained from Heraeus at a concentration of 1.3 weight % PEDOT in water.

The substrates used for various coatings were cellulose paper (CP), glass (GL), gold (Au), poly(ethylene terephthalate) (PET), and quartz (QZ).

### COMPARATIVE EXAMPLE 1

Using a plastic pipette, a coating of GO was deposited onto a GL substrate and the coating was allowed to dry in ambient air, ambient light, and room temperature (22° C.). The resulting dried GO sample on the glass substrate was analyzed by XRD. GO was identified in the dried coating, but no r-GO was detected, confirming that the analytical procedure of XRD did not convert GO to r-GO.

### COMPARATIVE EXAMPLE 2

Wet GO coatings were prepared using a stainless steel draw bar with defined gap spacing. Alternative wet GO coatings were generated using a plastic pipette. All of these wet GO samples (identified below) were coated on a defined substrate then dried in ambient air and ambient light using a Dataplate Series 720 Digital Hot Plate set to 60° C. The dried GO film samples were then exposed to a Xenon flash to replicate as close as possible the room temperature chemical free flash GO reduction process described in Journal of the American Chemical Society, 2009, vol. 131, pp. 11027-11032, using a Sunpak Auto544 Thyristor flash unit. The coated sample to flash unit face plate distance was 1 cm. For samples B, C, and D, a piece of black photo envelope paper was used as a mask to cover one half of the coated GO sample during Xenon flash exposure.

### GO-Coated Samples:

Sample A—GO coated on PET, 0.004 inch (0.01 cm) draw bar wet spacing;
Sample B—GO coated on PET, 0.004 inch (0.01 cm) draw bar wet spacing;
Sample C—GO coated on CP, 0.004 inch (0.01 cm) draw bar wet spacing;
Sample D—GO deposited on QZ using a plastic pipette;
Sample E—GO deposited on QZ using a plastic pipette; and
Sample F—GO deposited on PET, 0.006 inch (0.015 cm) draw bar wet spacing.

### Exposure Settings:

Sample A—F1.4 ASA25 for 5 exposures, F22 ASA800 for 1 exposure;
Sample B—F1.4 ASA 25 for 5 exposures;
Sample C—F1.4 ASA 25 5 for exposures;
Sample D—F1.4 ASA 25 for 5 exposures;
Sample E—F1.4 ASA 25 for 10 exposures; and
Sample F—F1.4 ASA 25 for 20 exposures.

In contrast to the experiments described in the noted JACS article, no visual color change was observed in Samples A-F resulting from to the Xenon light exposure. XRD analysis of Samples A-F indicated that GO was present in all of the samples both before and after Xenon light exposure. No r-GO was detected in any of the samples using XRD. These results indicate that exposure of GO to Xenon light according to the published teaching does not convert GO to r-GO.

### COMPARATIVE EXAMPLE 3

Using a plastic pipette, a coating of GO was deposited onto an Au foil as the substrate and allowed to dry in ambient air and ambient light at room temperature (22° C.). The dried GO coating (sample) was heated to and maintained at 600° C., exposed to X-rays using a ThermoVG Scientific X-ray Photoelectron Spectroscopy instrument, (Al anode, characteristic Kα wavelength 0.8345 nm), vacuum ambient, and power setting of 0.3 kilowatts energy for 150 minutes. After this X-ray exposure and thermal process, XRD showed the presence of graphite in the coating (sample), but no GO or r-GO was observed when the exposure and 600° C. heating in UHV was for at least 150 minutes. In other words, the GO was converted to graphite instead of r-GO. This is an undesirable result.

The results for Comparative Example 3 demonstrate that exposure of the GO coating (sample) on the Au substrate to X-rays at a temperature of 600° C. in UHV converted substantially all of the GO to graphite.

### COMPARATIVE EXAMPLE 4

Using a plastic pipette, GO was deposited onto an Au foil as the substrate and allowed to dry in ambient air and ambient light at room temperature (22° C.). The dried GO coating (sample) was heated to and maintained at 600° C. in vacuum. XRD showed the presence of graphite in the coating, but no GO or r-GO was observed after 150 minutes.

The results for Comparative Example 4 demonstrate that exposure of the GO coating (sample) on the Au substrate to only heating at a temperature of 600° C. in UHV converted substantially all of the GO to graphite.

### INVENTION EXAMPLE 1

Using a plastic pipette, GO was deposited onto a QZ substrate and allowed to dry in ambient air and ambient light at room temperature (22° C.). The dried GO coating (sample) was heated to and maintained at 100° C., exposed to UV using a Fischer 1000 Mercury Lamp equipped with a band pass filter resulting in a nominal output of a 365 nm beam at an energy output of 40 mJ/cm², air ambient for the defined periods of time as shown in TABLE VII below. After this UV exposure and thermal process, XRD showed the presence of GO and r-GO in the coating (sample), and a conversion of the GO to r-GO of at least 40% when the exposure and heating was at least 180 minutes.

TABLE I

| Exposure | | | | |
|---|---|---|---|---|
| and 100° C. | | | | Ratio |
| Thermal | Exposure | Normalized | Normalized r- | XRD |
| Process Time | Energy/time | GO XRD | GO XRD | Peak Area |
| (minutes) | (J/cm²) | Peak Area | Peak Area | r-GO/GO |
| 0 | 0 | 100.0 | 0.0 | 0 |
| 30 | 72 | 100.0 | 7.8 | 0.078 |
| 180 | 432 | 100.0 | 89.6 | 0.896 |
| 306 | 734 | 19.4 | 100.0 | 5.155 |

The results in TABLE I confirm that exposure of the GO coating (sample) on the QZ substrate to UV and 100° C. for an appropriate time and energy effectively converted at least 40% of the GO to r-GO.

### COMPARATIVE EXAMPLE 5

Using a plastic pipette, GO was deposited onto a QZ substrate and allowed to dry in ambient air and ambient light at room temperature (22° C.). The dried GO coating (sample) was heated to 100° C., air ambient for the defined period of time as shown in TABLE II below. After this thermal process, XRD showed the presence of GO and r-GO in the coating (sample), however the conversion of the GO to r-GO was determined to be less than 40% after 180 minutes.

TABLE II

| 100° C. Thermal | Normalized | Normalized r- | |
|---|---|---|---|
| Process Time | GO XRD | GO XRD Peak | Ratio XRD Peak Area |
| (minutes) | Peak Area | Area | r-GO/GO |
| 180 | 100 | 47.4 | 0.475 |

The results in TABLE II confirm that processing of the GO coating (sample) on the QZ substrate at 100° C. for an appropriate time did not effectively converted GO to r-GO.

The invention has been described in detail with particular reference to certain preferred embodiments thereof, but it will be understood that variations and modifications can be effected within the spirit and scope of the invention.

1. A method for reducing graphite oxide comprising:
exposing a sample comprising graphite oxide (GO) to UV radiation having a peak wavelength of less than 400 nm to change at least 40% of the graphite oxide (GO) to reduced graphite oxide (r-GO), wherein this exposing is carried out when the sample is at a temperature of at least 50° C. and up to and including 450° C.

2. The method of claim 1 comprising, exposing the sample comprising graphite oxide (GO) to the UV radiation to change at least 60% of the graphite oxide (GO) to reduced graphite oxide (r-GO).

3. The method of claim 1 comprising, exposing the sample comprising graphite oxide (GO) to UV radiation sufficient to provide at least 0.1 J/cm² to change at least 40% to reduced graphite oxide (r-GO).

4. The method of claim 1 comprising, exposing the sample comprising graphite oxide (GO) to UV radiation to provide reduced graphite oxide (r-GO) in a random pattern in the sample.

5. The method of claim 1 comprising, exposing the sample comprising graphite oxide (GO) to UV radiation to provide reduced graphite oxide (r-GO) in a predetermined non-random pattern in the sample.

6. The method of claim 1 comprising, exposing the sample comprising graphite oxide (GO) to radiation to provide reduced graphite oxide (r-GO), wherein the sample of graphite oxide (GO) is at a pressure of less than 100 torr.

7. The method of claim 1 comprising, exposing the sample comprising graphite oxide (GO) to UV radiation to provided reduced graphite oxide (r-GO), wherein the sample of graphite oxide (GO) is in a reducing environment.

8. The method of claim 1 comprising, exposing the sample comprising graphite oxide (GO) to UV radiation, wherein the sample is provided as a part of a surface coating on a substrate to provide reduced graphite oxide (r-GO) in the surface coating.

9. The method of claim 1 comprising, exposing the sample comprising graphite oxide (GO) to UV radiation, wherein the sample is provided as part of a surface coating on a non-oxidative substrate to provide reduced graphite oxide (r-GO) in the surface coating.

10. The method of claim 1 comprising, exposing the sample comprising graphite oxide (GO) to UV radiation, wherein the sample is provided as a component of a composite comprising an electronically conductive polymer to provide reduced graphite oxide (r-GO) in the composite.

11. The method of claim 1 comprising, exposing the sample comprising graphite oxide (GO) to UV radiation, wherein the sample is a component of a composite comprising one or more electronically conductive polymers that is a thiophene-containing polymer, aniline-containing polymer, or a pyrrole-containing polymer, to provide reduced graphite oxide (r-GO) in the composite.

12. The method of claim 1 comprising, exposing the sample comprising graphite oxide (GO) to UV radiation, wherein the sample is in the form of a coating having a thickness of less than 10 μm, to provide reduced graphite oxide (r-GO) in the coating.

13. The method of claim 1 comprising, exposing the sample comprising graphite oxide (GO) to UV radiation, wherein the sample is at least partially underneath a non-graphite oxide (GO) material, to provide reduced graphite oxide (r-GO) at least partially underneath the non-graphite oxide (GO) material.

14. The method of claim 1 comprising, exposing the sample comprising graphite oxide (GO) to UV radiation, wherein the sample is in the form of a single layer of graphene oxide, to provide reduced graphite oxide (r-GO) in the single layer.

15. The method of claim 1 comprising, exposing the sample comprising graphite oxide (GO) to UV radiation, wherein the sample is maintained at a temperature of less than 400° C. and a pressure of less than 760 torr, or the sample is maintained at the noted temperature while in a reducing environment.

16. The method of claim 1, comprising exposing the sample comprising graphite oxide (GO) when the sample is at a temperature of at least 75° C. and up to and including 400° C.
